(19) United States
(12) Patent Application Publication
(10) Pub. No.: US 2026/0211197 A1
(43) Pub. Date: Jul. 23, 2026

(54) OPTICAL MODULE AND PACKAGING METHOD

(71) Applicant: CLOUD INTELLIGENCE ASSETS HOLDING (SINGAPORE) PRIVATE LIMITED, Singapore (SG)

(72) Inventors: Yun BAO, Hangzhou, Zhejiang (CN); Anbin WANG, Hangzhou, Zhejiang (CN); Chongjin XIE, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/140,739

(22) PCT Filed: Dec. 15, 2023
(86) PCT No.: PCT/CN2023/139191

§ 371 Date: Jun. 18, 2025

(30) Foreign Application Priority Data
Dec. 18, 2022 (CN) 202211628886.5

(51) Int. Cl. G02B 6/42

(52) U.S. Cl. CPC G02B 6/4253; G02B 6/4248

(57) ABSTRACT

Embodiments of the present disclosure provide an optical module and a packaging method. In the optical module, a cover is above the optical system, and a sealant is between the cover and the optical system, such that the groove of the optical system can form a sealed air cavity. A sealant is between the optical module and the multi-channel optical fiber interface. In addition, a sealant is between the optical system and the circuit board.

This present disclosure claims priority to Chinese Patent Application No. 202211628886.5, filed on Dec. 18, 2022 with the title “OPTICAL MODULE AND PACKAGING METHOD” and the entire of which is combined in the present disclosure by reference.

### TECHNICAL FIELD

The present disclosure relates to the field of optical communications technologies, and in particular, to an optical module and a packaging method.

### BACKGROUND

At present, more and more data centers are put into operation and require a large number of optical module products, such as optical transceivers or AOC (Active Optical Cables). The simultaneous operation of the large number of optical modules generates a large amount of heat, which causes the temperature of the optical modules to increase continuously and affects the performance of the optical modules. In some typical scenarios, the device may be immersed in a liquid, and the device and the optical module can be cooled through the liquid.

However, when the optical path system of the optical module is immersed into the liquid, the refractive index of the optical path is changed, which causes the low optical coupling efficiency, thereby affecting the received optical power. Therefore, a new solution needs to be proposed.

### SUMMARY

A plurality of aspects of the present disclosure provide an optical module and a packaging method, to reduce impact on optical coupling efficiency when liquid cooling is performed on the optical module.

An embodiment of the present disclosure provides an optical module, including: an optical system, a circuit board, a multi-channel optical fiber interface, and a cover, where an upper surface of the optical system is provided with a groove configured to accommodate an air medium required for optical path propagation; and a side surface of the optical system, perpendicular to a light exit direction, is provided with a first optical fiber port; the cover covers the upper surface of the optical system, and a contact position between the cover and the upper surface of the optical system is provided with a first sealant to form a sealed air cavity between the cover and the groove; the multi-channel optical fiber interface is mounted at the first optical fiber port, and a contact position between the multi-channel optical fiber interface and the first optical fiber port is provided with a second sealant to hermetically connect the multi-channel optical fiber interface with the first optical fiber port; and a bottom of the optical system is mounted on the circuit board and coupled to an optical component on the circuit board, and a contact position between a lower surface of the optical system and the circuit board is provided with a third sealant to hermetically connect the optical system with the circuit board.

An embodiment of the present disclosure further provides a method of packaging an optical module, including: determining an optical system to be packaged, where an upper surface of the optical system is provided with a groove configured to accommodate an air medium required for optical path propagation, and a side surface of the optical system, perpendicular to a light exit direction, is provided with a first optical fiber port; mounting a multi-channel optical fiber interface at the first optical fiber port, and coupling the optical system mounted with the multi-channel optical fiber interface to an optical component on a circuit board; covering a cover on the upper surface of the optical system, and performing a sealing connection on a contact position between the upper surface of the optical system and the cover by using a sealant to form an air cavity between the cover and the groove; and performing a sealing connection between the multi-channel optical fiber interface and the first optical fiber port by using a sealant, and performing a sealing connection between a lower surface of the optical system and the circuit board by using a sealant.

### BRIEF DESCRIPTION OF THE DRAWINGS

The drawings described herein are used to provide a further understanding of the present disclosure and constitute a part of the present disclosure, and the exemplary embodiments of the present disclosure and the description thereof are used to explain the present disclosure and do not constitute an improper limitation to the present disclosure. In the drawings:

FIG. 1 is a cross-sectional structural diagram of an optical module in a sealed state according to an exemplary embodiment of the present disclosure;

FIG. 2 is a schematic structural diagram of an optical module in an unsealed state according to an exemplary embodiment of the present disclosure;

FIG. 3 is a schematic structural diagram of an optical module in a sealed state according to an exemplary embodiment of the present disclosure;

FIG. 4 is a schematic diagram of an exploded structure of an optical system, a cover, and a multi-channel optical fiber interface according to an exemplary embodiment of the present disclosure;

FIG. 5 is a schematic diagram of an optical module filled with potting sealant according to an exemplary embodiment of the present disclosure;

FIG. 6 is a schematic structural diagram of a fence of an optical module according to an exemplary embodiment of the present disclosure;

FIG. 7 is a schematic structural diagram of a shield and a rubber stopper of an optical module according to an exemplary embodiment of the present disclosure;

FIG. 8 is a schematic diagram of a case in which a shield covers an optical module according to an exemplary embodiment of the present disclosure;

FIG. 9 is a schematic structural diagram of a rubber stopper according to an exemplary embodiment of the present disclosure;

FIG. 10 is a schematic flowchart of a method of packaging an optical module according to an exemplary embodiment of the present disclosure.

### DETAILED DESCRIPTION OF THE EMBODIMENTS

To make the objectives, technical solutions, and advantages of the present disclosure clearer, the following clearly and completely describes the technical solutions of the present disclosure with reference to specific embodiments of the present disclosure and corresponding accompanying drawings. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

Terms used in embodiments of the present disclosure are merely intended to describe specific embodiments, but are not intended to limit the present disclosure. The singular forms “a,” “said” and “the” used in the embodiments of the present disclosure and the appended claims are also intended to include plural forms, unless the context clearly indicates otherwise, “a plurality of” generally includes at least two, but does not exclude the case of including at least one.

It should be understood that the term “and/or” used herein is merely an association relationship describing associated objects, indicating that there may be three relationships, for example, A and/or B may indicate three cases: A exists alone, both A and B exist, and B exists alone. In addition, the character “/” in this specification generally indicates an “or” relationship between the associated objects.

It should also be noted that the terms “include,” “comprise” or any other variations thereof are intended to cover non-exclusive inclusion, such that a product or system including a series of elements includes not only those elements, but also other elements not explicitly listed, or elements inherent to such a product or system. Without more limitations, an element defined by the statement “including a . . . ” does not exclude the existence of other identical elements in the commodity or system including the element.

For a technical problem in the related art that a refractive index of an optical path changes when an optical module is liquid-cooled, thereby affecting received optical power, some embodiments of the present disclosure provide a solution, and the technical solutions provided in the embodiments of the present disclosure are described in detail below with reference to the accompanying drawings.

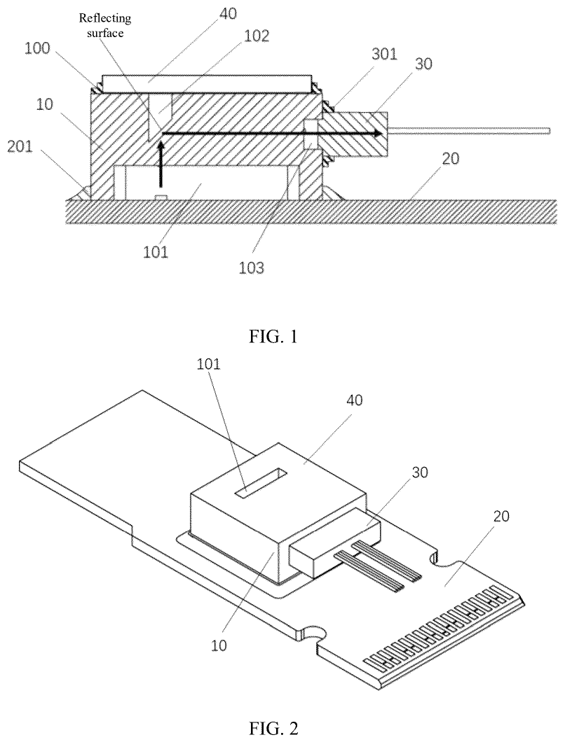

FIG. 1 is a schematic structural diagram of an optical module according to an embodiment of the present disclosure, as shown in FIG. 1, the optical module includes:
an optical system 10, a circuit board 20, a multi-channel optical fiber interface (ferrule) 30, and a cover 40.

The circuit board 20 is provided with an optical component, such as a laser and/or a photodiode (PD). FIG. 1 illustrates a laser 101 as an example. The optical system 10 is coupled to an optical component on the circuit board 20, and functions to couple a signal light emitted by the laser at a transmitting end into an optical fiber at a transmitting end, and couple an optical signal in an optical fiber at a receiving end into a photodiode at a receiving end.

The optical system 10 includes a groove 102 and a first optical fiber port 103. The groove 102 is on an upper surface of the optical system 10, and is configured to accommodate an air medium required for optical path propagation. As shown in FIG. 1, below the bottom surface of the groove 102 is a reflective surface, and the air medium in the groove 102 is used to meet the medium requirement for reflecting the optical path on the reflective surface. The first optical fiber port 103 is on a side surface, that is perpendicular to the light exit direction, of the optical system 10.

The laser 101 may be a vertical cavity surface emitting laser (VCSEL). The laser emitted by the vertical cavity surface emitting laser is emitted perpendicular to the top surface thereof, and has characteristics of narrow spectrum, low power consumption, low temperature drift and the like. The laser light emitted by the laser is incident on the reflective surface below the groove 102, and the reflective surface and the incident direction of the laser light may form an angle of 45 degrees, so as to reflect the laser light incident in the vertical direction as a laser light emitted in the horizontal direction. As shown in FIG. 1, the groove 102 above the reflective surface may be used to accommodate air, and the air in the groove may form an air medium to meet the light path refraction requirement. As shown in FIG. 1, a first optical fiber port 103 is on a side surface, that is on a light exit path of the laser light, of the optical system 10.

The cover 40 is above the upper surface of the optical system 10, and a contact position between the cover 40 and the upper surface of the optical system 10 is provided with a first sealant 100, that is, the cover 40 and the upper surface of the optical system 10 are hermetically connected by using a sealant to form a sealed air cavity between the cover 40 and the groove. The first sealant 100 between the cover 40 and the upper surface of the optical system 10 may be applied along a seam between an edge of the cover 40 and the upper surface of the optical system, to form a sealant layer at the seam, to prevent the coolant in the liquid cooling environment from entering the groove on the upper surface of the optical system 10, thereby ensuring that the air medium and the reflective surface are not damaged.

The multi-channel optical fiber interface 30 is configured to connect to the optical system 10 to couple an optical signal from the optical system at a transmitting end to an optical fiber of the multi-channel optical fiber interface 30 at a transmitting end, and to couple an optical signal from the multi-channel optical fiber interface at a receiving end to a receiving end of the optical system. The multi-channel optical fiber interface 30 may be mounted in the first optical fiber port 103, to couple transmitted laser light into an optical fiber. The multi-channel optical fiber interface 30 is hermetically connected to the first optical fiber port 103 by using a second sealant 301.

The second sealant 301 between the multi-channel optical fiber interface 30 and the first optical fiber port 103 may be applied along a seam between an outer edge of the multi-channel optical fiber interface 30 and the first optical fiber port 103, to form a sealant layer at the seam, thereby preventing the coolant in the liquid cooling environment from entering the optical system 10 and damaging the optical path.

The circuit board 20 is configured to control the laser, and may process a received optical signal (for example, perform photoelectric conversion processing). A bottom of the optical system 10 is mounted on the circuit board 20, and a lower surface of the optical system 10 is hermetically connected with the circuit board 20 by using a third sealant 201. The third sealant 201 between the lower surface of the optical system 10 and the circuit board 20 may be applied along a seam between an outer edge of the lower surface of the optical system 10 and the circuit board 20, to form a sealant layer at the seam, thereby preventing the coolant in the liquid cooling environment from entering the optical system 10 and damaging the optical path.

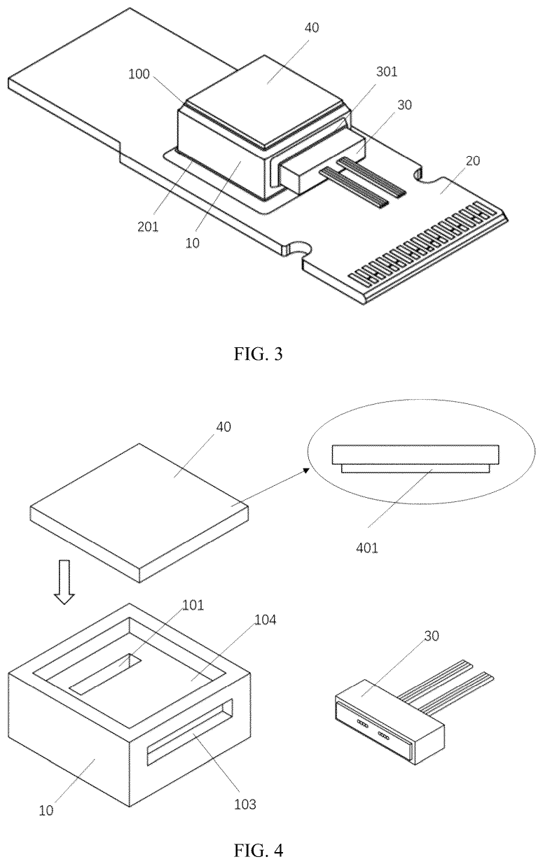

As shown in FIG. 2, when the optical module is packaged, the optical system 10 may be provided on the circuit board 20, the cover 40 may be placed above the optical system 10, and the applying operation of the first sealant, the second sealant, and the third sealant may be performed. A schematic diagram of an optical module obtained after sealing is shown in FIG. 3.

In this embodiment, in the optical module, a cover is above the optical system, and a sealant is between the cover and the optical system, such that a sealed air cavity can be formed in the groove of the optical system, thereby preventing a coolant used during liquid cooling from entering the groove and affecting a medium required for optical path propagation. A sealant is between the optical module and the multi-channel optical fiber interface, such that a risk that the coolant enters the optical module from the optical fiber interface can be reduced. In addition, a sealant is between the optical system and the circuit board, to reduce a risk that the coolant enters the optical system from a gap between the optical system and the circuit board. Based on this structure, the tightness of the optical module is greatly improved, and when the optical module is immersed in the coolant for heat dissipation, impact on optical coupling efficiency of the optical module can be reduced, thereby effectively protecting optical performance of the optical system.

In an embodiment, as shown in FIG. 4, an upper surface of the optical system 10 is provided with a recessed step 104, and a lower surface of the cover 40 is provided with a protrusion portion 401 mated with the recessed step 104. The cover 40 is mounted in the recessed step 104 through the protrusion portion 401, and the first sealant 100 is provided at a contact position between the protrusion portion 401 and the recessed step 104.

The recessed step 104 mating with the protrusion portion 401 indicates that an inner size of the recessed step 104 is the same as an outer size of the protrusion portion 401, or the outer size of the protrusion portion 401 is slightly smaller than the inner size of the recessed step 104, such that the protrusion portion 401 is mounted at the recessed step 104, and there is no gap or a small gap between the recessed step 104 and the protrusion portion 401. The first sealant 100 between the protrusion portion 401 and the recessed step 104 may form a sealant layer to fill the small gap.

In an embodiment, the sealant layer may be applied at the gap between the protrusion portion 401 mounted on the recessed step 104 after the protrusion portion 401 is mounted on the recessed step 104. For example, the first sealant 100 may be pre-applied in the recessed step 104 before the protrusion portion 401 is mounted. That is, when packaging the optical module, the sealant may be first applied at the recessed step 104, and the protrusion portion 401 is mounted on the sealant when the sealant is not cured. After the sealant is cured, a tight sealant may be formed between the recessed step 104 and the protrusion portion 401. This embodiment is not limited. In this manner, the sealant layer may be integrally formed by applying, which may further improve the sealing performance and reduce the risk of the coolant immersing into the groove 102.

As shown in FIG. 4, a mounting base of the multi-channel optical fiber interface 30 may also be a stepped structure, such that the first optical fiber port 103 may be embedded into a narrower part of the mounting base, which is convenient for mounting and sealing process construction.

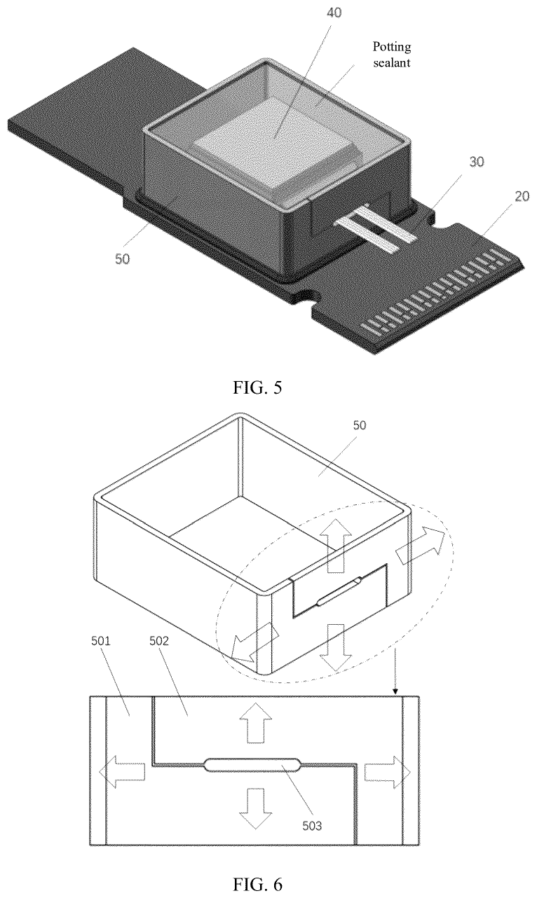

In an embodiment, a fence 50 is mounted outside the optical system 10, and a space formed by the fence 50 and the optical system 10 is provided with a potting sealant filling layer, as shown in FIG. 5. A size of the fence 50 is greater than an outer size of the optical system 10, that is, a length, a width, and a height of the fence 50 may be respectively greater than a length, a width, and a height of the optical system 50. The fence 50 is configured to fix the potting sealant in a specific area outside the optical system 10 when filling the potting sealant.

In an embodiment, the potting sealant filling layer may be a transparent thermally conductive sealant filling layer. That is, in the process of packaging the optical module, the fence 50 may be disposed outside the optical system 10, and the thermally conductive sealant is filled in the space between the fence 50 and the optical system 10 in a filling manner to obtain the potting sealant filling layer. The potting sealant filling layer has good thermal conductivity, such that the optical system can be cooled and dissipated by using the coolant.

In addition, the potting sealant filling layer has a transparent property, which is beneficial to monitoring the state of the potting sealant and observing whether bubbles exist in the potting sealant during the filling process. The potting sealant filling layer can firmly fix the optical system on the circuit board 20, thereby reducing the displacement of each component of the optical system 10 at different temperatures, and can also reduce the displacement between the optical system 10 and the circuit board 20 at different temperatures, thereby reducing the influence on the light emission and light reception of the optical system.

In an embodiment, as shown in FIG. 6, a surface of the fence 50 corresponding to the first optical fiber port 103 includes a first component 501 and a second component 502 that are separated.

The first component 501 is provided with a first opening at a position corresponding to the first optical fiber port 103, and the second component 502 is provided with a second opening at the position corresponding to the first optical fiber port 103, and the first opening and the second opening form a through hole 503 for passing through the optical fiber, as shown in FIG. 6.

The first component 501 and the second component 502 may be separatable in a direction away from the through hole 503. That is, as shown in FIG. 6, the first component 501 and the second component 502 may be separated to two sides in a vertical direction (opposite directions), and the first component 501 and the second component 502 may also be separated to two sides in a horizontal direction (opposite directions), so as to facilitate penetrating the optical fiber array.

Based on this implementation, after the multi-channel optical fiber interface 30 is mounted on the optical system 10, the optical fiber connected to the multi-channel optical fiber interface 30 may be put into the through hole 503 by rotating (for example, opening outward) the first component 501 and the second component 502, thereby further reducing packaging difficulty of the optical module and avoiding damage to the optical fiber.

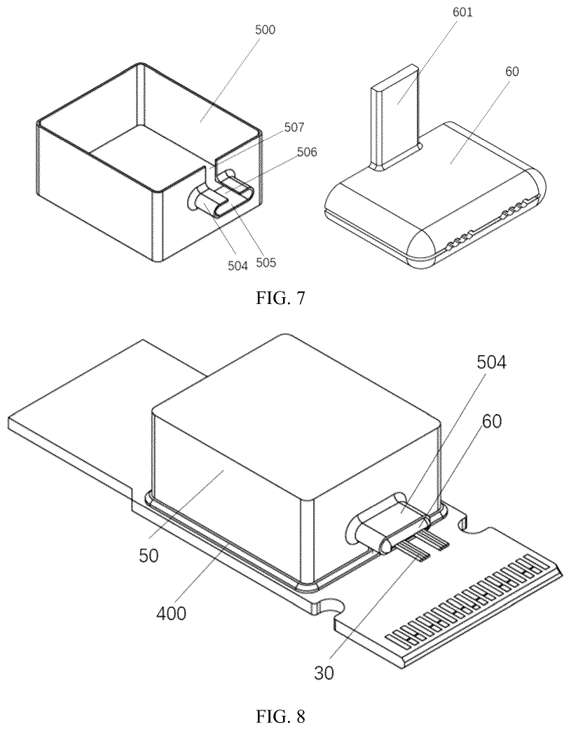

In another embodiment, the exterior of the optical system 10 is mounted with a shield 500 as shown in FIG. 7. As shown in FIG. 8, the shield 500 covers the optical system 10, and a contact position between the shield 500 and the circuit board 20 is provided with a fourth sealant 400.

The shield 500 may be a cubic box structure with five surfaces closed and one surface open. The closed surfaces include four side surfaces and a top surface, and the open surface is a bottom surface. When the shield 500 covers the optical system 10, the optical system 10 can be surrounded by the open surface, and the fourth sealant 400 may be between the four side surfaces and the circuit board 20, to shield and seal the optical system 100.

The optical fiber connected to the multi-channel optical fiber interface 30 may be inserted into a rubber stopper 60 to meet the requirements of optical fiber fixing and sealing inside the shield 500. In this implementation, a second optical fiber port 504 is on a surface of the shield 500 corresponding to the first optical fiber port 103, and the second optical fiber port 504 penetrates along an inserting direction of the optical fiber to form an accommodating cavity 505 of the rubber stopper 60, as shown in FIG. 7. The size of the rubber stopper 60 is adapted to the size of the accommodating cavity 505, and the rubber stopper 60 is embedded in the accommodating cavity 505 to seal the shield 500.

In an implementation, as shown in FIG. 7, a horizontal plane of the second optical fiber port 504 has a third opening 506, and the shield 500 has a fourth opening 507 in communication with the third opening 506. The third opening 506 and the fourth opening 507 are configured to place the optical fiber connected to the multi-channel optical fiber interface 30 into the second optical fiber port 504. That is, after the multi-channel optical fiber interface 30 is mounted on the optical system 10, the optical fiber connected to the multi-channel optical fiber interface 30 may be put into the second optical fiber port 504 through the third opening 506 and the fourth opening 507, which further reduces the packaging difficulty of the optical module and avoids damage to the optical fiber.

After the optical fiber is placed in the second optical fiber port 504, the optical fiber may be inserted into the rubber stopper 60, and the rubber stopper 60 is inserted into the accommodating cavity 505.

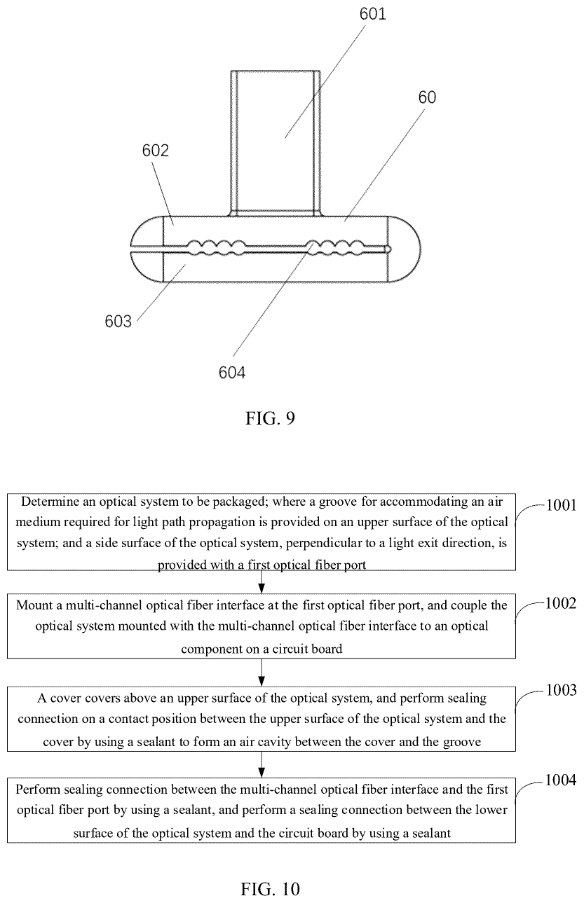

In an embodiment, as shown in FIG. 7 and FIG. 9, a vertical plate 601 adapted to the fourth opening 507 may be provided on a horizontal surface of the rubber stopper 60; when the rubber stopper 60 is embedded in the accommodating cavity 505, the vertical plate 601 may seal the fourth opening 507, thereby preventing the coolant from entering the interior of the shield 500 through the fourth opening 507.

In an embodiment, as shown in FIG. 9, the rubber stopper 60 may include a first body 602 and a second body 603. One end of the first body 602 and one end of the second body 603 in the horizontal direction are fixedly connected, and the other end of the first body 602 and the other end of the second body 603 in the horizontal direction are separately disposed. When the rubber stopper 60 is not embedded in the accommodating cavity 505, the first body 601 and the second body 603 are able to be opened and closed with the fixed connection ends of the first body and the second body as a shaft, to allow the optical fiber to pass through. That is, after the optical fiber is placed in the second optical fiber port 504, the first body 601 and the second body 603 may be opened to a relatively large angle, such that the optical fiber is quickly inserted into the rubber stopper 60, thereby reducing packaging difficulty.

As shown in FIG. 9, corresponding positions of the first body 602 and the second body 603 are respectively provided with semi-circular holes, and when the rubber stopper 60 is embedded in the accommodating cavity 505, the semi-circular holes at the corresponding positions of the first body 602 and the second body 603 are closed to form through holes 604 for fixing the optical fiber. A size of a through hole 604 is adapted to an outer diameter of the optical fiber, which can improve the tightness of the shield 500 while fixing the optical fiber.

Based on this implementation, when the multi-channel optical fiber interface 30 has been mounted on the first optical fiber port 103, the optical fiber connected to the multi-channel optical fiber interface 30 may be placed into the rubber stopper 60 without obstruction, thereby avoiding a potential danger caused by directly inserting the optical fiber in the rubber stopper.

After the shield 500 shown in FIG. 7 and the rubber stopper shown in FIG. 9 are placed outside the sealed optical module shown in FIG. 3, the optical module shown in FIG. 8 is obtained. The optical module shown in FIG. 8 can be completely immersed in the coolant, to improve a cooling effect.

An embodiment of the present disclosure further provides a method of packaging an optical module, as shown in FIG. 10, the method includes following steps: at step 1001, an optical system to be packaged is determined; a groove for accommodating an air medium required for light path propagation is provided on an upper surface of the optical system; and a side surface of the optical system, perpendicular to a light exit direction, is provided with a first optical fiber port. At step 1002: a multi-channel optical fiber interface is mounted at the first optical fiber port, and the optical system mounted with the multi-channel optical fiber interface is coupled to an optical component on a circuit board. At step 1003: a cover covers above an upper surface of the optical system, and sealing connection is performed on a contact position between the upper surface of the optical system and the cover by using a sealant to form an air cavity between the cover and the groove. At step 1004: sealing connection is performed between the multi-channel optical fiber interface and the first optical fiber port by using a sealant, and a sealing connection is performed between the lower surface of the optical system and the circuit board by using a sealant.

The optical component on the circuit board may include a laser and a photodiode (PD).

In the foregoing process, after the multi-channel optical fiber interface is mounted at the first optical fiber port, and the optical system mounted with the multi-channel optical fiber interface is coupled to the optical component on the circuit board, an optical path formed by the optical component, the optical system, and the optical fiber port may be debugged, to ensure that the optical module has a good optical performance.

In this implementation, a cover is above the optical system, and a sealant is between the cover and the optical system, such that a sealed air cavity can be formed in the groove of the optical system, thereby preventing a coolant used during liquid cooling from entering the groove and affecting a medium required for optical path propagation. A sealant is between the optical module and the multi-channel optical fiber interface, such that a risk that the coolant enters the optical module from the optical fiber interface can be reduced. In addition, a sealant is between the optical system and the circuit board, to reduce a risk that the coolant enters the optical system from a gap between the optical system and the circuit board. Based on this structure, the tightness of the optical module is greatly improved, and when the optical module is immersed in the coolant for heat dissipation, impact on optical coupling efficiency of the optical module can be reduced, thereby effectively protecting optical performance of the optical system.

In an embodiment, a fence is mounted outside the optical system, and a potting sealant is filled in a space formed by the fence and the optical system to form a potting sealant filling layer. The potting sealant may be a transparent thermally conductive sealant, such that in the process of filling the potting sealant, bubbles in the potting sealant may be observed, and a controllable filling process of the potting sealant is realized.

Based on the fence, the potting sealant filling layer can be fixed in a specific area outside the optical module, and the waterproof sealing can be performed again based on the potting sealant filling layer, which greatly improves the waterproof capability of the packaged optical module.

In an implementation, a shield may be mounted outside the optical system, and the optical fiber connected to the multi-channel optical fiber interface is inserted into the rubber stopper; and then the rubber stopper may be embedded in the accommodating cavity of the shield, and a sealant is applied at a contact position between the shield and the circuit board.

When the shield is mounted, the shield may cover the optical system. The shield may be a cubic box structure with five surfaces closed and one surface open. The closed surfaces include four side surfaces and a top surface, and the open surface is a bottom surface. When the shield covers the optical system, the optical system can be surrounded by the open surface, and the closed surfaces may shield the optical system.

When the optical fiber is inserted into the rubber stopper, the first body and the second body of the rubber stopper can be opened, and the optical fiber is placed into the through hole for fixing the optical fiber in the rubber stopper through the gap formed by the first body and the second body. An inner diameter of the through hole matches an outer diameter of the optical fiber, such that when the optical fiber is placed in the through hole, a sealing effect can be formed on the through hole. Of course, in some embodiments, after the optical fiber is placed into the through hole, the contact position between the optical fiber and the through hole may be subjected to glue dispensing treatment, thereby further improving the sealing performance of the through hole.

The size of the rubber stopper matches the size of the accommodating cavity of the shield, such that when the rubber stopper is embedded into the accommodating cavity, the accommodating cavity can be tightly closed. In an embodiment, after the rubber stopper is embedded into the accommodating cavity, the contact position between the rubber stopper and the accommodating cavity may be subjected to glue dispensing treatment, thereby further improving the sealing performance of the accommodating cavity.

After the mounting of the rubber stopper is completed, the connection between the shield and the circuit board may be connected by a sealant to improve the tightness of the shield.

In this embodiment, by the shield, the rubber stopper, and the sealing operations, the sealed optical module can be waterproof sealed again, which greatly improves the waterproof capability of the optical module.

In the optical module provided in this embodiment of the present disclosure, a cover is above the optical system, and a sealant is between the cover and the optical system, such that a sealed air cavity can be formed in a groove of the optical system, thereby preventing a coolant used during liquid cooling from entering the groove and affecting a medium required for optical path propagation. A sealant is between the optical module and the multi-channel optical fiber interface, such that a risk that the coolant enters the optical module from the optical fiber interface can be reduced. In addition, a sealant is between the optical system and the circuit board, to reduce a risk that the coolant enters the optical system from a gap between the optical system and the circuit board. Based on this structure, the tightness of the optical module is greatly improved, and when the optical module is immersed in the coolant for heat dissipation, impact on optical coupling efficiency of the optical module can be reduced, thereby effectively protecting optical performance of the optical system.

It should be noted that descriptions such as “first” and “second” in this specification are used to distinguish between different messages, devices, modules, and the like, and do not represent a sequence, and “first” and “second” are not limited to different types.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a CD-ROM, an optical memory, and the like) that include computer-usable program code.

This disclosure is described with reference to the flowcharts and/or block diagrams of the method, the device (system), and the computer program product according to the embodiments of the present disclosure. It will be understood that each flow and/or block in the flowcharts and/or block diagrams, and combinations of flows and/or blocks in the flowcharts and/or block diagrams, can be implemented by computer program instructions. These computer program instructions may be provided to a general-purpose computer, a special-purpose computer, an embedded processor, or a processor of another programmable data processing device to generate a machine, such that the instructions executed by the computer or the processor of the another programmable data processing device generate an apparatus for implementing a function specified in one or more procedures in the flowcharts and/or one or more blocks in the block diagrams.

These computer program instructions may also be stored in a computer-readable memory that can guide a computer or another programmable data processing device to work in a specific manner, such that the instructions stored in the computer-readable memory generate a product including an instruction apparatus, and the instruction apparatus implements a function specified in one or more processes in the flowcharts and/or one or more blocks in the block diagrams.

These computer program instructions may also be loaded onto a computer or other programmable data processing device to cause a series of operational steps to be performed on the computer or other programmable device to produce computer-implemented processing, such that the instructions executed on the computer or other programmable device provide steps for implementing the functions specified in one or more flows of the flowcharts and/or one or more blocks of the block diagrams.

In a typical configuration, a computing device includes one or more processors (CPUs), an input/output interface, a network interface, and a memory.

The memory may include a form such as a volatile memory, a random access memory (RAM), and/or a non-volatile memory in a computer-readable medium, for example, a read-only memory (ROM) or a flash RAM. Memory is an example of computer-readable media.

Computer readable media includes both volatile and non-volatile, removable and non-removable media capable of storing information by any method or technology. The information may be computer-readable instructions, data structures, modules of a program, or other data. Examples of computer storage media include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, magnetic disk storage or other magnetic storage devices, or any other non-transmission media, which can be used to store information that can be accessed by a computing device. As defined herein, the computer-readable medium does not include transitory media, such as modulated data signals and carrier waves.

It should also be noted that the terms “include”, “comprise” or any other variations thereof are intended to cover non-exclusive inclusion, such that a process, method, product or device including a series of elements includes not only those elements, but also other elements not explicitly listed, or elements inherent to such a process, method, product or device. An element proceeded by “comprises a . . . ” does not, without more constraints, preclude the existence of additional identical elements in the process, method, article, or device that comprises the element.

The foregoing descriptions are merely embodiments of the present disclosure and are not intended to limit the present disclosure. For those skilled in the art, the present disclosure may have various modifications and variations. Any modification, equivalent replacement, or improvement made without departing from the spirit and principle of the present disclosure shall fall within the scope of the claims of the present disclosure.

1. An optical module comprises:
an optical system, a circuit board, a multi-channel optical fiber interface, and a cover;
wherein an upper surface of the optical system is provided with a groove for accommodating an air medium required for light path propagation; and a side surface of the optical system, perpendicular to a light exit direction, is provided with a first optical fiber port;
the cover covers an upper surface of the optical system, and a contact position between the cover and the upper surface of the optical system is provided with a first sealant to form a sealed air cavity between the cover and the groove;
the multi-channel optical fiber interface is mounted at the first optical fiber port, and a contact position between the multi-channel optical fiber interface and the first optical fiber port is provided with a second sealant to hermetically connect the multi-channel optical fiber interface with the first optical fiber port; and
a bottom of the optical system is mounted on the circuit board, and the optical system is coupled to an optical component on the circuit board, and a contact position between a lower surface of the optical system and the circuit board is provided with a third sealant to hermetically connect the optical system with the circuit board.

2. The optical module according to claim 1, wherein the upper surface of the optical system is provided with a recessed step; a lower surface of the cover is provided with a protrusion portion mated with the recessed step; the cover is mounted at the recessed step through the protrusion portion; and a contact position between the protrusion portion and the recessed step is provided with the first sealant.

3. The optical module according to claim 2, wherein a fence is mounted outside the optical system, and a space formed by the fence and the optical system is provided with a potting sealant filling layer.

4. The optical module according to claim 3, wherein the potting sealant filling layer is a transparent thermally conductive sealant filling layer.

5. The optical module according to claim 3, wherein a surface of the fence corresponding to the first optical fiber port comprises a first component and a second component that are separated;
wherein the first component is provided with a first opening at a position corresponding to the first optical fiber port, and the second component is provided with a second opening at the position corresponding to the first optical fiber port; and the first opening and the second opening form a through hole for passing through an optical fiber; and
the first component and the second component are separable in a direction away from the through hole.

6. The optical module according to claim 2, wherein a shield is mounted outside the optical system, the shield covers the optical system, and a contact position between the shield and the circuit board is provided with a fourth sealant; and
an optical fiber connected to the multi-channel optical fiber interface is inserted into a rubber stopper; a second optical fiber port is provided on a surface of the shield corresponding to the first optical fiber port, and the second optical fiber port penetrates along an insertion direction of the optical fiber to form an accommodating cavity of the rubber stopper; and the rubber stopper is embedded in the accommodating cavity.

7. The optical module according to claim 6, wherein a horizontal plane of the second optical fiber port comprises a third opening; the shield comprises a fourth opening communicated with the third opening; and the third opening and the fourth opening are configured to place the optical fiber connected to the multi-channel optical fiber interface into the second optical fiber port; and
wherein the rubber stopper is provided with a vertical plate adapted to the fourth opening; and when the rubber stopper is embedded in the accommodating cavity, the vertical plate seals the fourth opening.

8. The optical module according to claim 6, wherein the rubber stopper comprises a first body and a second body, one end of the first body in a horizontal direction and one end of the second body in the horizontal direction are fixedly connected, and the other end of the first body in the horizontal direction and the other end of the second body in the horizontal direction are separated; and when the rubber stopper is not embedded in the accommodating cavity, the first body and the second body are able to be opened and closed with fixedly connected ends of the first body and the second body as a shaft for passing through the optical fiber; and
wherein a corresponding position of the first body and a corresponding position of the second body are respectively provided with a semi-circular hole, and when the rubber stopper is embedded in the accommodating cavity, the semi-circular hole at the corresponding positions of the first body and the second body is closed to form a through hole for fixing the optical fiber.

9. A method of packaging an optical module, comprising:
determining an optical system to be packaged, wherein an upper surface of the optical system is provided with a groove for accommodating an air medium required for light path propagation, and a side surface of the optical system, perpendicular to a light exit direction, is provided with a first optical fiber port;
mounting a multi-channel optical fiber interface at the first optical fiber port, and coupling the optical system mounted with the multi-channel optical fiber interface to an optical component on a circuit board;
covering a cover above an upper surface of the optical system, and performing sealing connection on a contact position between the upper surface of the optical system and the cover by using a sealant to form an air cavity between the cover and the groove; and
performing sealing connection between the multi-channel optical fiber interface and the first optical fiber port by using a sealant, and performing sealing connection between a lower surface of the optical system and the circuit board by using a sealant.

10. The method according to claim 9, further comprising:
mounting a fence on an exterior of the optical system mounted with the multi-channel fiber optic interface; and
filling a potting sealant in a space formed by the fence and the optical system to form a potting sealant filling layer.

11. An electronic device, comprising a memory, a processor, and a computer program stored on the memory, wherein the processor, when executing the computer program, implements the method according to claim 9.

12. A computer-readable storage medium, wherein the computer-readable storage medium stores a computer program, and when the computer program is executed by a processor, the processor implements the method according to claim 9.
